(19) United States
(12) Patent Application Publication
(10) Pub. No.: US 2010/0026915 A1
(43) Pub. Date: Feb. 4, 2010

(54) DIGITAL PHOTOALBUM

(75) Inventors: Eric Pozin, Davie, FL (US); Sherry Thompson, Plantation, FL (US); Daniel W. Forbes, Pembroke Pines, FL (US)

Correspondence Address: Casimir Jones, S.C., 2275 DEMING WAY, SUITE 310, MIDDLETON, WI, 53562, US

(73) Assignee: Atico International, Inc., Fort Lauderdale, FL (US)

(21) Appl. No.: 12/489,930

(22) Filed: Jun. 23, 2009

Related U.S. Application Data
(60) Provisional application No. 61/074,904, filed on Jun. 23, 2008.

(51) Int. Cl. H04N 5/64; B42D 5/00

(52) U.S. Cl. 348/838; 281/38; 348/E05.128

(57) ABSTRACT

The present invention relates to photoalbums. In particular, the present invention relates to photoalbums designed for receiving, securing, and displaying printed images and digital images.

### CROSS-REFERENCE TO RELATED APPLICATIONS

This application claims priority to U.S. Provisional Application Ser. No. 61/074,904, filed Jun. 23, 2008, herein incorporated by reference in its entirety.

### FIELD OF THE INVENTION

The present invention relates to photoalbums. In particular, the present invention relates to photoalbums designed for receiving, securing, and displaying printed images and digital images.

### BACKGROUND

A photographic album, or photoalbum, is a collection of a series of photographs, generally in a book. Some albums have compartments which the photos may be slipped into; others albums have heavy paper with sticky substance and on top, a piece of large plastic in which photos can be put between. Older style albums often were simply books of heavy paper which photos could be glued to or attached to with adhesive corners, or pages.

### SUMMARY OF THE INVENTION

The present invention relates to photoalbums. In particular, the present invention relates to photoalbums designed for receiving, securing, and displaying printed images and digital images.

In particular, in certain embodiments, the present invention provides albums for viewing images comprising, for example, a front cover, a back cover, a spine, a printed image display region, and one or more digital image display regions. In some embodiments, the front cover and back cover are connected with the spine in a book-type manner. In some embodiments, the printed image display region is connected with the spine such that the printed image display region is positioned between the front cover and back cover. In some embodiments, the one or more digital image display regions is positioned between the front cover and back cover. In some embodiments, the front cover and back cover are configured for opening in a book-type manner so as to expose the printed image display region. In some embodiments, the front cover and back cover are configured for opening in a book-type manner so as to expose the one or more digital image display regions.

The printed image display region is not limited to a particular manner of displaying printed images. In some embodiments, the printed image display region is one or more sheets configured to receive and secure printed images. In some embodiments, the sheets are transparent. In some embodiments, the sheets are plastic. In some embodiments, the sheets are cardboard. The printed image display region is not limited to a particular number of sheets. In some embodiments, the one or more sheets is 1 sheet, 2 or more sheets, 3 or more sheets, 5 or more sheets, 10 or more sheets, 50 or more sheets, and 100 or more sheets. The printed image display region is not limited to a particular type of printed image. In some embodiments, the printed image is a printed photograph.

The one or more digital image display region is not limited to a particular manner for displaying digital images. In some embodiments, the digital image display region is a digital frame. In some embodiments, the digital frame comprises a screen for displaying digital images. The digital image display region is not limited to displaying a particular type of digital image. In some embodiments, the digital image is a digital photograph. In some embodiments, the digital image is a digital film. In some embodiments, the one or more digital frames is secured within the back cover, the front cover, and/or the printed image display region. The digital image display region is not limited to a particular amount of digital frames (e.g., 1 digital frame, 2 or more digital frames, 3 or more digital frames, 5 or more digital frames, 10 or more digital frames, 50 or more digital frames, and 100 or more digital frames).

The front cover is not limited to a particular material. In some embodiments, the material of the front cover is, for example, plastic, cardboard, and/or metal. The back cover is not limited to a particular material. In some embodiments, the material of the back cover is, for example, plastic, cardboard, and/or metal. The spine is not limited to a particular material. In some embodiments, the material of the spine is, for example, plastic, cardboard and/or metal.

### DESCRIPTION OF THE FIGURES

FIG. 1 shows an embodiment of the present invention.

FIG. 2 shows an embodiment of the present invention.

FIG. 3 shows an embodiment of the present invention.

### DETAILED DESCRIPTION

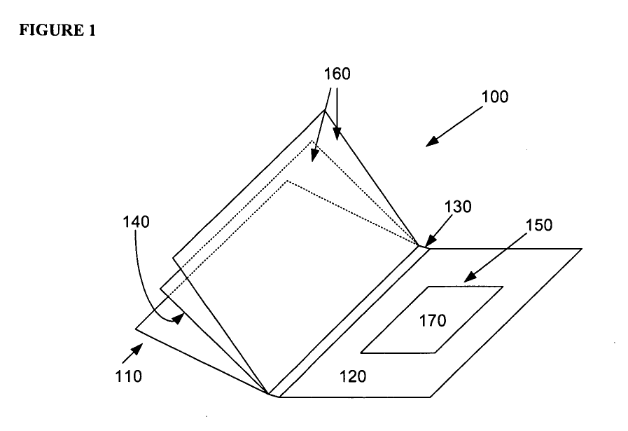

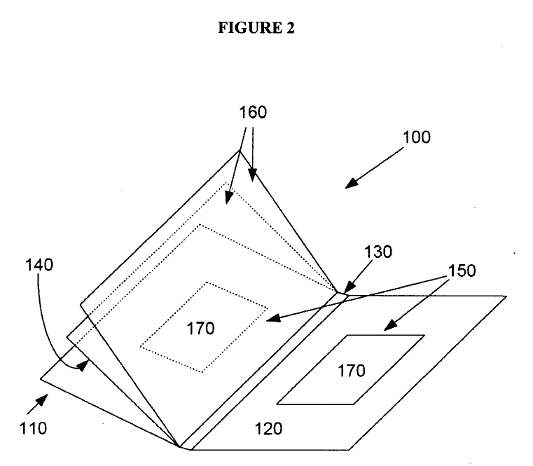

The following discussion relates to photoalbums configured to display printed images and digital images. FIGS. 1 and 2 illustrate certain embodiments of the present invention. The present invention is not limited to these particular embodiments.

The photoalbums of the present invention are designed to overcome the limitations of traditional photoalbums by permitting the display and/or storage of both printed images (e.g., traditional photographs printed on photographic paper) and digital images (e.g., JPEG images). The photoalbums of the present invention provide numerous advantages over traditional photoalbums incapable of digital image display including, but not limited to, an enhanced photographic experience, and an improved ability to store and display higher numbers of images.

The photoalbums of the present invention are not limited to a particular configuration. FIG. 1 shows a photoalbum embodiment of the present invention. As shown in FIG. 1, the photoalbum 100 comprises a front cover 110, a back cover 120, a spine 130, a printed image display region 140, and a digital image display region 150. The photoalbum 100 is not limited to a particular size. In some embodiments, the size of the photoalbum 100 is such that it is able to display one or more printed images of any desired size (e.g., 3″×5″; 4″×6″; 5″×7″; 8″×10″; 8″×12″) (e.g., any digital or non-digital printed image size). In some embodiments, the size of the photoalbum 100 is such that it is able to display digital images of any desired size (e.g., 3″×5″; 4″×6″; 5″×7″; 8″×10″; 8″×12″) (e.g., any digital or non-digital image size). The photoalbum 100 is not limited to a particular weight. In some embodiments, the weight of the photoalbum 100 is such that it may be manually transported by a user.

Still referring to FIG. 1, the photoalbum 100 is not limited to a particular type of front cover 110 and back cover 120. In some embodiments, the front cover 110 and back cover 120 serve as a protective element for the photoalbum 100. The front cover 110 and back cover 120 is not limited to a particular material. In some embodiments, the material of the front cover 110 and back cover 120 is approximately identical. In some embodiments, the material of the front cover 110 and back cover 120 is cardboard. In some embodiments, the material of the front cover 110 and back cover 120 is leather. In some embodiments, the material of the front cover 110 and back cover 120 is plastic. In some embodiments, the material of the front cover 110 and back cover 120 is metal. In some embodiments, the front cover 110 and back cover 120 is laminated. The front cover 110 and back cover 120 are not limited to particular size dimensions. In some embodiments, the size dimensions of the front cover 110 and back cover 120 are identical. In some embodiments, the size dimensions of the front cover 110 and back cover 120 are such that the photoalbum 100 is able to display printed images of any desired size and digital images of any desired size. The front cover 110 and back cover 120 are not limited to a particular arrangement. In some embodiments, the front cover 110 and back cover 120 are arranged in a book-type configuration such that a user may access printed images and digital images positioned between the front cover 110 and back cover 120. In some embodiments, the front cover 110 and/or back cover 120 are configured to receive and secure a digital image display region 150.

Still referring to FIG. 1, the photoalbum 100 is not limited to a particular type of spine 130. In some embodiments, the spine 130 serves as an interface between the front cover 110 and back cover 120. In some embodiments, the front cover 110 and back cover 120 are attached with the spine 130 in a book-type configuration. In some embodiments, the front cover 110 and back cover 120 are able to independently open and close while remaining attached with the spine 130. The front cover 110 and back cover 120 are not limited to a particular manner of attachment with the spine 130. In some embodiments, the front cover 110 and back cover 120 attach to the spine 130 with, for example, staples, glue, binding, clamping, etc. In some embodiments, the front cover 110 and back cover 120 are attached to the spine 130 such that the attachment remains intact despite normal usage by a user. In some embodiments, the spine 130 is a wired coil. The spine 130 is not limited to a particular material. In some embodiments, the material of the spine 130 is identical with the material of the front cover 110 and/or the back cover 120. In some embodiments, the material of the spine 130 is cardboard. In some embodiments, the material of the spine 130 is leather. In some embodiments, the material of the spine 130 is plastic. In some embodiments, the material of the spine 130 is metal. In some embodiments, the spine 130 is laminated. The spine 130 is not limited to a particular size dimension. In some embodiments, the size dimensions of the spine 130 are identical to the length of the front cover 110 and/or the back cover 120. In some embodiments, the size dimensions of the spine 130 is such that the photoalbum 100 is able to display printed images of any desired size and digital images of any desired size. In some embodiments, the front cover 110 and back cover 120 are arranged in a book-type configuration such that a user may access printed images and digital images positioned between the front cover 110 and back cover 120.

Still referring to FIG. 1, the photoalbum 100 is not limited to a particular type of printed image display region 140. The printed image display region 140 is not limited to displaying a particular type of printed image. In some embodiments, the printed image is a digital or non-digital printed photograph. In some embodiments, the printed image is any kind of image (e.g., digital or non-digital) on any type of paper (e.g., photograph paper, magazine paper, news paper, facsimile paper, etc.).

Still referring to FIG. 1, in some embodiments, the printed image display region 140 comprises one or more sheets 160 designed for displaying printed images. The printed image display region 140 is not limited to a particular type of sheet 160 designed for displaying printed images. In some embodiments, the sheets 160 are plastic sheets (e.g., transparent plastic sheets). In some embodiments, the sheets 160 are paper sheets. In some embodiments, the sheets 160 are cardboard sheets. The printed image display region 140 is not limited to a particular number of sheets 160. In some embodiments, the printed image display region 140 has one sheet 160. In some embodiments, the printed image display region 140 has two or more sheets 160 (e.g., 2 sheets, 3 sheets, 5 sheets, 10 sheets, 25 sheets, 100 sheets, 500 sheets, etc.). In some embodiments, the printed image display region 140 is configured to accommodate any desired number of sheets 160. The printed image display region 140 is not limited to a particular manner of displaying printed images with the sheets 160 designed for displaying printed images. In some embodiments, the sheets 160 have therein one or more slots (e.g., 1 slot, 2 slots, 3 slots, 4 slots, 5 slots, 10 slots, etc.) for receiving, for example, a portion of a printed image (e.g., the corners of a printed image) thereby securing the printed image. In some embodiments, the sheets 160 have therein sleeves for receiving and displaying printed images (e.g., transparent sleeves configured to receive and secure a printed image such that it is visible). In some embodiments, the sheets 160 have a surface that accommodates adhesion (e.g., glue, tape) of a printed image. In some embodiments, each side of a sheet 160 is configured to display printed images. In some embodiments, the sheets 160 have an opening (e.g., an opening in the center) and/or transparent portion such that a digital image display region 150 positioned in the back cover 120 may be seen through such an opening and/or transparent portion despite there being one or more sheets 160 positioned over the digital image display region 150.

Still referring to FIG. 1, the sheets 160 are not limited to a particular size dimension. In some embodiments, the size dimensions of the sheets 160 are consistent with the front cover 110 and/or the back cover 120. In some embodiments, the size dimensions (e.g., thickness, length, width) of the sheets 160 is such that the photoalbum 100 is able to display printed images of any desired size and digital images of any desired size. The sheets 160 for displaying printed images are not limited to a particular manner of attachment with the photoalbum 100. In some embodiments, the spine 130 serves as an interface between the sheets 160, the front cover 110 and the back cover 120. In some embodiments, the sheets 160 are attached with the spine 130 in a book-type configuration. In some embodiments having two or more sheets 160, each sheets 160 may be independently opened and closed while remaining attached with the spine 130. The sheets 160 are not limited to a particular manner of attachment with the spine 130. In some embodiments, the sheets 160 attach to the spine 130 with, for example, staples, glue, binding, clamping, etc. In some embodiments, the sheets 160 are attached to the spine 130 such that the attachment remains intact despite normal usage by a user.

Still referring to FIG. 1, the photoalbum 100 is not limited to a particular type of digital image display region 150. The digital image display region 150 is not limited to displaying a particular type of digital image. In some embodiments, the digital image is a digital photograph in any type of digital format (e.g., JPEG, RAW, TIFF, BMP) and any type of compression. In some embodiments, the digital image is a digital film (e.g., video) in any type digital format (e.g., MPEG, AVI, WMV) and any type of compression. The digital image display region 150 is not limited to a particular location within the photoalbum 100. In some embodiments, the digital image display region 150 is located on the interior side of the back cover 120. In some embodiments, the digital image display region 150 is located on the exterior side of the back cover 120. In some embodiments, the digital image display region 150 is located on the interior side of the front cover 110. In some embodiments, the digital image display region 150 is located on the exterior side of the front cover 110. In some embodiments, the digital image display region 150 is located within the printed digital image display region 140 (e.g., attached onto one of the sheets 160).

Still referring to FIG. 1, in some embodiments, the digital image display region 150 comprises one or more (e.g., 1, 2, 5, 10, 15, 20, etc.) digital frames 170 designed for displaying digital images. The digital image display region 150 is not limited to a particular type of digital frame 170 designed for displaying digital images. Indeed, one skilled in the art is well aware of a plethora of commercially available digital frames 170 (e.g., Aluratek products; Audiovox products; Axion products; Ceiva Logic products; Coby products; Digital Spectrum Solutions products; Goldlantern products; Kodak products; Matsunichi products; Mustek products; Philips products; Portable USA products; Quantaray products; Senario products; Smartparts products; Viewsonic products; Westinghouse products; jWIN products).

In some embodiments, the digital frame 170 appears like a traditional frame but is configured to display a digital image on, for example, a liquid crystal or plasma screen. In some embodiments, the digital frame 170 includes a memory for holding a digital image, an interface through which it can receive a digital image from another device, and a processing system capable of displaying a stored digital image on the screen. In some embodiments, the memory for the digital frame 170 is capable of storing multiple digital images. In some embodiments, the processing system for the digital frame 170 is capable of periodically changing the display from one digital image to another (e.g., randomly, pre-programmed). In some embodiments, the digital frame 170 may be treated as an archive directory. The digital frames 170 are not limited to particular size dimensions. In some embodiments, the size dimensions of the digital frames 170 are consistent with the size dimensions of the front cover 110 and/or the back cover 120. In some embodiments, the digital frames 170 are battery operated. In some embodiments, the digital frames 170 have therein USB connections and may communicate (e.g., provide and receive information) with external memory cards. In some embodiments, the digital frames 170 have therein a hard drive (e.g., 700 MB, 1 GB, 10 GB, 100 GB, 500 GB, 1 TB, 100 TB, 1000 TB). In some embodiments, the digital frames 170 have therein audio speakers. In some embodiments, the digital frames 170 are configured to play digital audio (e.g., MP3 audio; audio from a digital film). In some embodiments, the digital frames 170 are configured to wirelessly communicate (e.g., provide and receive information). The digital frames 170 are not limited to a particular manner of attachment within the photoalbum 100. In some embodiments, the front cover 110 and/or back cover 120 have therein chambers for receiving and securing a digital frame 170. In some embodiments, the front cover 110 and/or back cover 120 have therein one or more slots (e.g., 1 slot, 2 slots, 3 slots, 4 slots, 5 slots, 10 slots, etc.) for receiving and securing, for example, a portion of a digital frame 170 (e.g., the corners of a digital frame). In some embodiments, the front cover 110 and/or back cover 120 have therein sleeves for receiving and displaying a digital frame 170 (e.g., transparent sleeves configured to receive and secure a digital frame 170 such that it is visible). In some embodiments, the front cover 110 and/or back cover 120 have a surface that accommodates adhesion (e.g., glue, tape) of a digital frame 170. In some embodiments, the digital frame 170 attached to front cover 110 and/or back cover 120 such that it remains secured despite normal usage by a user. In some embodiments, the photoalbum 100 comprises one digital frame 170 secured on the interior side of the front cover 110, and one digital frame 170 secured on the interior side of the back cover 120.

FIG. 2 shows an embodiment of a photoalbum 100 comprising a front cover 110 and back cover 120 attached to a spine 130 in a book-type configuration with a printed image display region 140 comprising two sheets 160, and a digital image display region 150 comprising two digital frames 170. As shown, the photoalbum 100 is shown in an “open” configuration wherein the interior sides of the front cover 110 and back cover 120 are visible. As shown, one of the digital frames 170 is secured with the interior side of the front cover 110, and one of the digital frames 170 is secured with the interior face of the back cover 120.

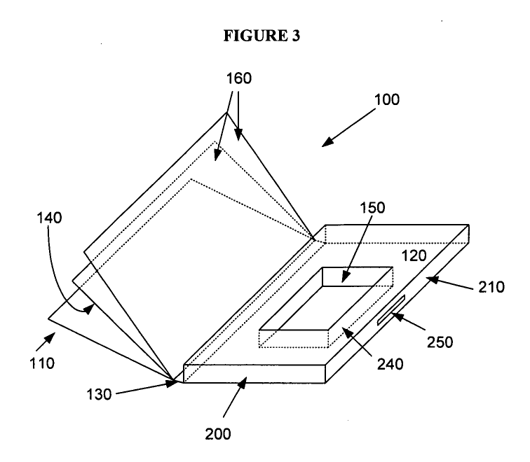

FIG. 3 shows an embodiment of a photoalbum 100 comprising a front cover 110 and back cover 120 attached to a spine 130 in a book-type configuration with a printed image display region 140 comprising two sheets 160, and a digital image display region 150 configured to display a digital frame. As shown, the photoalbum 100 is shown in an “open” configuration wherein the interior sides of the front cover 110 and back cover 120 are visible. As shown, the back cover 120 has a compartment for housing a digital image display device, the compartment having a back cover bottom side face 200 and a back cover edge side face 210. In some embodiments, the back cover bottom side face 200 and the back cover edge side face 210 are designed to appear as stacked sheets of paper, pages, or other faux representations. In some embodiments, the compartment has therein a display device chamber 240. In some embodiments, the size dimensions of the display device chamber 240 are sufficient to secure a digital frame such that a user can view the view screen of the display device through the opening at the digital image display region 150. In some embodiments, the back cover edge face 210 has therein a port 250 that permits a user to access, for example, a memory access point on the display device, a battery compartment, a cable, or other feature of the display device. In preferred embodiments, the display device chamber and the display device is larger than the opening so that the display device is physically held in place by the walls of the chamber without permitting the display device to exit through the opening. In some embodiments, all or a portion of the back cover edge side face pivots down or up (not shown) to allow the display device to be inserted or removed from the compartment. In some embodiments, the embodiment described in FIG. 3 may be interchanged for the front cover and the back cover.

All publications and patents mentioned in the above specification are herein incorporated by reference. Although the invention has been described in connection with specific certain embodiments, it should be understood that the invention as claimed should not be unduly limited to such specific embodiments. Indeed, various modifications of the described modes for carrying out the invention that are obvious to those skilled in the relevant fields are intended to be within the scope of the following claims.

We claim:

1. A device for viewing images, comprising:
a front cover, a back cover, a spine, a printed image display region, and one or more digital image display regions,
wherein said front cover and back cover are connected with said spine in a book-type manner,
wherein said printed image display region is connected with said spine such that said printed image display region is positioned between said front cover and back cover, and
wherein said one or more digital image display regions is positioned between said front cover and back cover.

2. The device of claim 1, wherein said printed image display region is one or more sheets configured to receive and secure printed images.

3. The device of claim 2, wherein said sheets are transparent.

4. The device of claim 2, wherein said sheets are plastic.

5. The device of claim 2, wherein said sheets are cardboard.

6. The device of claim 2, wherein said one or more sheets is selected from the group consisting of 1 sheet, 2 or more sheets, 3 or more sheets, 5 or more sheets, 10 or more sheets, 50 or more sheets, and 100 or more sheets.

7. The device of claim 2, wherein said printed image is a printed photograph.

8. The device of claim 1, wherein said one or more digital image display regions is a digital frame configured to display one or more digital images.

9. The device of claim 8, wherein said one or more digital images is one or more digital photographs.

10. The device of claim 8, wherein said one or more digital images is one or more digital films.

11. The device of claim 8, wherein said one or more digital frames is secured with the back cover.

12. The device of claim 8, wherein said one or more digital frames is secured with the front cover.

13. The device of claim 8, wherein said one or more digital frames is secured with the printed image display region.

14. The device of claim 8, wherein said one or more digital frames is 1 digital frame, 2 or more digital frames, 3 or more digital frames, 5 or more digital frames, 10 or more digital frames, 50 or more digital frames, and 100 or more digital frames.

15. The device of claim 1, wherein the material of said front cover comprises at least one of plastic, cardboard, and metal.

16. The device of claim 1, wherein the material of said back cover comprises at least one of plastic, cardboard, and metal.

17. The device of claim 1, wherein the material of said spine comprises at least one of plastic, cardboard, and metal.

18. The device of claim 1, wherein said front cover and back cover are configured for opening in a book-type manner so as to expose said printed image display region.

19. The device of claim 1, wherein said front cover and back cover are configured for opening in a book-type manner so as to expose said one or more digital image display regions.
